(19) United States
(12) Patent Application Publication
(10) Pub. No.: US 2026/0054825 A1
(43) Pub. Date: Feb. 26, 2026

(54) SYSTEM FOR INCAPACITATION DETECTION BASED ON PILOT PERCEPTION

(71) Applicant: Rockwell Collins, Inc., Cedar Rapids, IA (US)

(72) Inventor: Cheyenne B. Matthews, Marion, IA (US)

(21) Appl. No.: 18/814,282

(22) Filed: Aug. 23, 2024

(51) Int. Cl. B64C 13/18; G05D 1/81; G05D 109/22

(52) U.S. Cl. CPC B64C 13/18; G05D 1/817; G05D 2109/22

(57) ABSTRACT

A pilot monitoring system is configured to monitor the current status of an aircraft, and determine if the pilot is likely experiencing perception-based incapacitation. Based on accumulated data, certain aircraft states (control positions, flight phase, etc.) can be associated with a likelihood of perception-based incapacitation. The system may characterize pilot inputs during periods of likely perception-based incapacitation, and take remedial action when actual perception-based incapacitation is identified.

### BACKGROUND

In aviation, spatial disorientation is the mistaken perception of one’s position and motion relative to the earth. For example, during a go-around, pilots may apply “full throttle,” which will cause the pilot to feel that the aircraft is climbing due to forces felt because of forward accelerating. If a pilot incorrectly perceives the aircraft as climbing, they may nose down to compensate, resulting in loss of altitude and potentially controlled flight into terrain.

There is currently no active system for detecting spatial disorientation for pilots during flight other than a second pilot monitoring the flight deck. It would be advantageous to have a system and method in place to detect disorientation during single pilot operation.

### SUMMARY

In one aspect, embodiments of the inventive concepts disclosed herein are directed to a system configured to monitor the current status of an aircraft, and determine if the pilot is likely experiencing perception-based incapacitation. Based on accumulated data, certain aircraft states (control positions, flight phase, etc.) can be associated with a likelihood of perception-based incapacitation.

In a further aspect, the system may characterize pilot inputs during periods of likely perception-based incapacitation, and take remedial action when actual perception-based incapacitation is identified.

It is to be understood that both the foregoing general description and the following detailed description are exemplary and explanatory only and should not restrict the scope of the claims. The accompanying drawings, which are incorporated in and constitute a part of the specification, illustrate exemplary embodiments of the inventive concepts disclosed herein and together with the general description, serve to explain the principles.

### BRIEF DESCRIPTION OF THE DRAWINGS

The numerous advantages of the embodiments of the inventive concepts disclosed herein may be better understood by those skilled in the art by reference to the accompanying figures in which:

FIG. 1 shows a representation of aircraft vectors;

FIG. 2A shows a graph of certain aircraft characteristics during flight according to an exemplary embodiment;

FIG. 2B shows a graph of a flight path related to inertial vectors;

FIG. 3 shows a block diagram of a system suitable for implementing embodiments of the present disclosure; and

FIG. 4 shows a block representation of a neural network suitable for implementing embodiments of the present disclosure.

### DETAILED DESCRIPTION

Before explaining various embodiments of the inventive concepts disclosed herein in detail, it is to be understood that the inventive concepts are not limited in their application to the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein a letter following a reference numeral is intended to reference an embodiment of a feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Also, while various components may be depicted as being connected directly, direct connection is not a requirement. Components may be in data communication with intervening components that are not illustrated or described.

Finally, as used herein any reference to “one embodiment,” or “some embodiments” means that a particular element, feature, structure, or characteristic described in connection with the embodiment is included in at least one embodiment of the inventive concepts disclosed herein. The appearances of the phrase “in at least one embodiment” in the specification does not necessarily refer to the same embodiment. Embodiments of the inventive concepts disclosed may include one or more of the features expressly described or inherently present herein, or any combination or sub-combination of two or more such features.

Broadly, embodiments of the inventive concepts disclosed herein are directed to a system configured to monitor the current status of an aircraft, and determine if the pilot is likely experiencing perception-based incapacitation. Based on accumulated data, certain aircraft states (control positions, flight phase, etc.) can be associated with a likelihood of perception-based incapacitation. The system may characterize pilot inputs during periods of likely perception-based incapacitation, and take remedial action when actual perception-based incapacitation is identified.

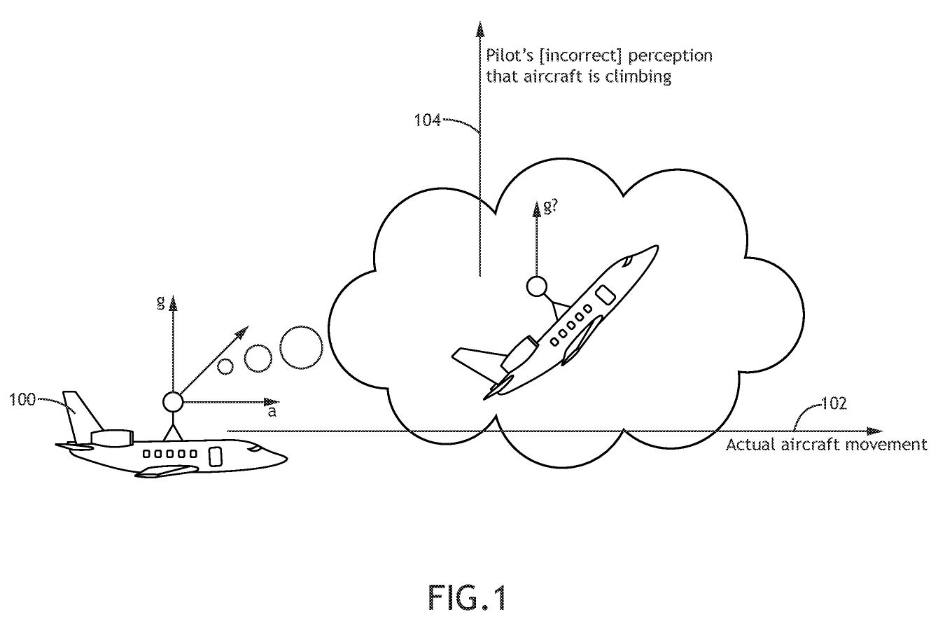

Referring to FIG. 1, a representation of aircraft vectors is shown. During flight, an aircraft 100 may accelerate (or decelerate) along a vector 102. Such acceleration may create an erroneous perception of climbing (or descending) along an orthogonal vector 104. That is to say, the force of acceleration may create a perception that the direction of gravity has changed, falsely indicating the aircraft 100 has pitched up or down. Such perception may cause the pilot to compensate with control inputs that put the aircraft 100 in an undesirable state.

Spatial Disorientation may not present itself in biomedical physiological signals (eye-tracking, functional near-infrared spectroscopy, pulse oximetry, etc.) in time to stop a mishap; and is responsible for greater than 10% of mishaps.

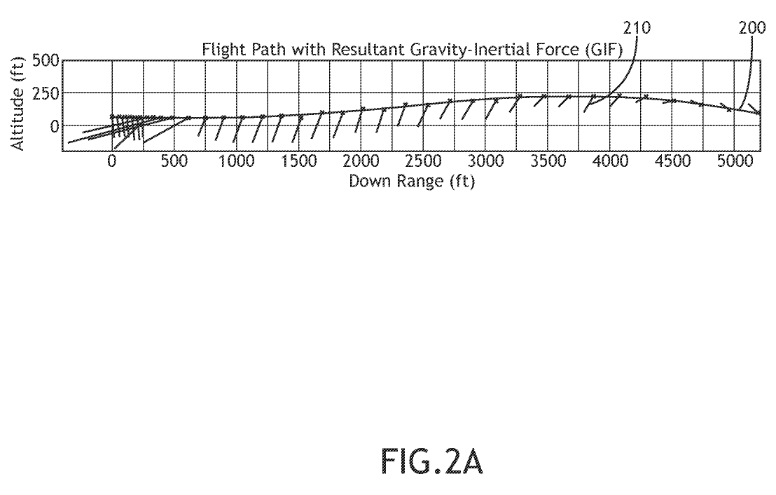

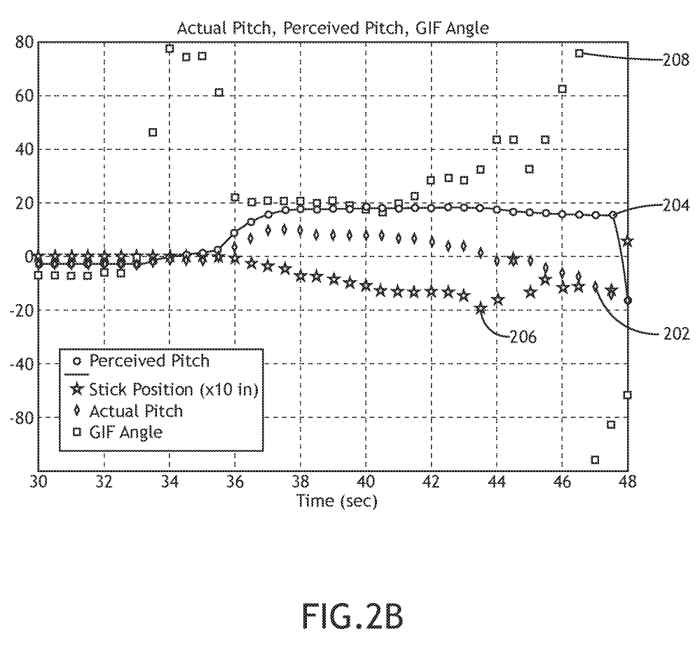

Referring to FIGS. 2A and 2B, graphs of certain aircraft characteristics during flight according to an exemplary embodiment are shown. In a graph of vector data in FIG. 2A, as an aircraft accelerates, a relationship is shown between aircraft pitch 200 and a gravity-inertial vector 210 (the combined vector of gravity and inertia due to acceleration, represented as a direction and a magnitude). The gravity-inertial vector 210 influences a pilot’s perception of aircraft pitch based on a purely gravitational vector. The pilot may feel the gravity-inertial vector 210 when modifying control / power inputs (thrust and / or stick / yoke). The gravity-inertial force 210 may be incorrect as compared to the actual path / pitch of the aircraft. For example, as shown in FIG. 2A, many gravity-inertial vectors 210 illustrated show a force vector downwards and backwards (pushing back) on the pilot, resulting in the pilot feeling as if they are climbing (incorrect), when in actuality the aircraft flight path 200 is relatively stable.

With reference to FIG. 2B, a pilot may interpret a gravity-inertial vector 208 (such as illustrated by the gravity-inertial vector 210 of FIG. 2A) as a perceived pitch 204 and manipulate the stick position 206 accordingly. It may be appreciated that, without sufficient visual cues, the actual pitch 202 may diverge from the perceived pitch 204 so significantly, that the pilot may put the aircraft in an unsafe state. As shown in FIG. 2B, for example, between approximately 30 sec and 36 sec, the pilot’s perceived pitch 204 is consistent with the aircraft’s actual pitch 202 (as measured in degrees of pitch angle) as there are few or relatively small inertial forces as compared to gravity. Beginning at approximately 36 sec, the pilot’s perceived pitch 204 begins to diverge from the aircraft’s actual pitch 202 when the stick position 206 (stick movement away from the neutral position) causes a change to the actual pitch 202 with a corresponding change to the gravity-inertial vector 208. Divergence between the perceived pitch 204 and actual pitch 202, as shown in FIG. 2B, may lead the pilot to control the aircraft in an unsafe manner.

Furthermore, it may be appreciated that the relations illustrated in FIG. 2 may comprise a portion of a dataset that may be used to train a machine learning algorithm to recognize situations where perceived pitch 208 due to gravity-inertial vector 208 may cause the pilot to make erroneous adjustments to the stick position 206.

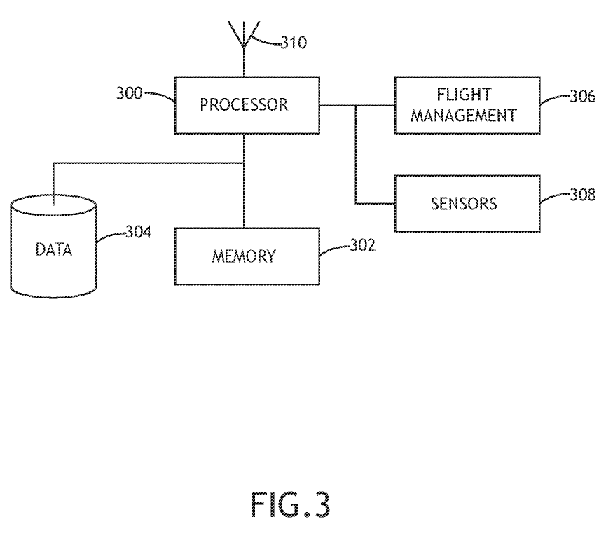

Referring to FIG. 3, a block diagram of a system suitable for implementing embodiments of the present disclosure is shown. The system includes a processor 300, and memory 302 in data communication with the processor 300 for embodying processor executable code. The processor 300 receives data from a flight management system 306 such as the current and historic state of the aircraft and the current flight phase. Flight phase may be defined as climbing, descent, takeoff, and landing; each flight phase may define distinct criteria for aircraft states and remedial action based on pilot perception. For example, the processor 300 may receive data corresponding to the speed, acceleration, altitude, pitch, etc. of the aircraft. Furthermore, the processor 300 may receive data from one or more sensors 308 aboard the aircraft.

The processor 300 is configured to identify aircraft states associated with incapacity due to perceived pitch. In at least one embodiment, the processor 300 may be configured to execute a function associating various identified parameters. Alternatively, or in addition, the processor 300 may be configured to embody a trained neural network.

In at least one embodiment, spatial disorientation maps can be created by post-processing flight recorder data to recreate pilot perception versus actual aircraft state during an event, usually as a part of crash investigation. Pilot perception is a known formula that is currently calculated during post-crash investigation. Embodiments of the present disclosure may utilize such formula in real-time using pre-defined algorithms. A function or trained neural network may embody a model of “perceived pitch” of the aircraft based on control inputs of the aircraft and the actual aircraft state data.

Where the processor 300 embodies a function, the processor 300 compares real-time “perceived pitch” curves to aircraft state data (i.e. “actual pitch”). If the current pilot control inputs match the “perceived pitch” (i.e., incorrect) instead of the actual pitch, the processor 300 may execute some remedial action. For example, the processor 300 may assume control to correct the issue. Alternatively, or in addition, the processor 300 may utilize a communication interface 310 to communicate a relevant warning to ground / flight control.

Embodiments of the present disclosure may enable single pilot operations to identify potential spatial disorientation in the pilot. Furthermore, even in dual-pilot platforms, it is possible for both pilots to suffer spatial disorientation. Existing methodologies for removing control authority from the pilot when they deviate a specified amount past “expected” input does not cover emergency situations where aircraft controls may be abruptly moved (go around, birds, missed approach, ATC canceled clearance, etc.).

In one exemplary embodiment, where a pilot is on an Instrument Landing System (ILS) approach and missed for some reason, the aircraft may get down to a one-hundred or two-hundred foot decision altitude and the pilot does not have the items that are necessary for a visual approach, the pilot may initiate a go around. In that scenario, at full thrust the aircraft should pitch up a couple of degrees for the autopilot, but the pilot can override that. The processor 300 could identify such scenario and prevent excessive pitch up that might otherwise risk a stall.

In at least one embodiment, the processor 300 may continuously log data and corresponding pilot inputs in a data storage element 304 to refine the perceived pitch models. In at least one embodiment, perceived pitch models may be specific to each pilot based on historical data for that pilot within the context of flight recorder data for perceived pitch related mishaps.

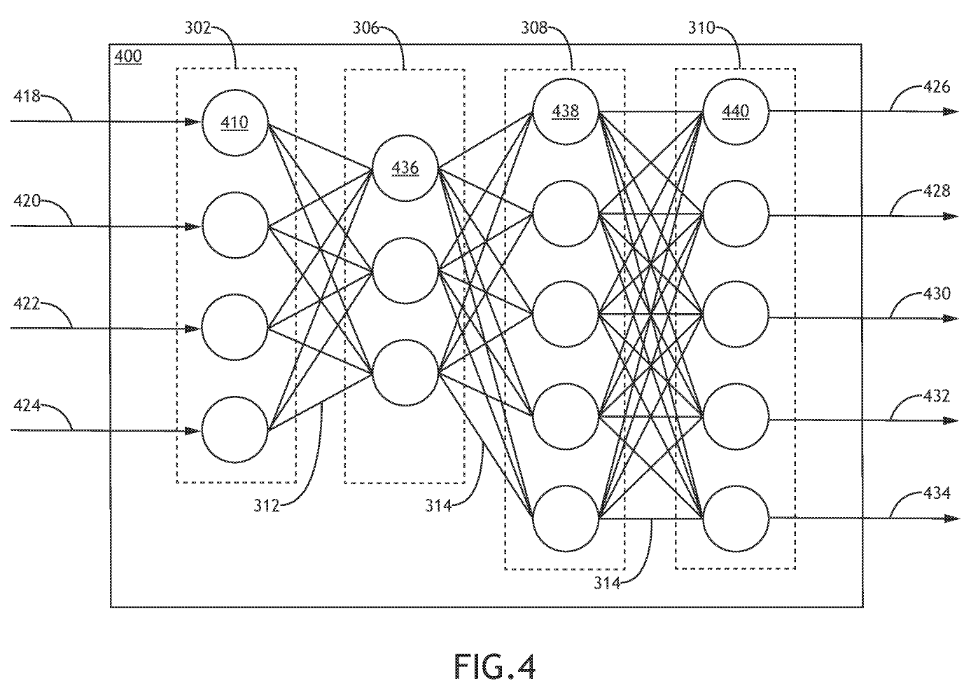

Referring to FIG. 4, a block diagram of a neural network 400 according to an exemplary embodiment of the inventive concepts disclosed herein is shown. The neural network 400 comprises an input layer 402, an output layer 404, and a plurality of internal layers 406, 408. Each layer comprises a plurality of neurons or nodes 410, 436, 438, 440. In the input layer 402, each node 410 receives one or more inputs 418, 420, 422, 424 corresponding to a digital signal and produces an output 412 based on an activation function unique to each node 410 in the input layer 402. An activation function may be a Hyperbolic tangent function, a linear output function, and / or a logistic function, or some combination thereof, and different nodes 410, 436, 438, 440 may utilize different types of activation functions. In at least one embodiment, such activation function comprises the sum of each input multiplied by a synaptic weight. The output 412 may comprise a real value with a defined range or a Boolean value if the activation function surpasses a defined threshold. Such ranges and thresholds may be defined during a training process. Furthermore, the synaptic weights are determined during the training process.

During the training process, the neural network 400 may be defined to associated inputs such as flight control data, aircraft data, airspeed, control inputs from the yoke, control inputs for the thrust and the rudder, etc., with outputs corresponding to an indication of perception-based incapacitation and / or remedial action when perception-based incapacitation is likely, along with inputs contrary to what is actually called for.

Certain models have been created by the NTSB based on data from flight data recorders. Such models embody perceived pitch versus actual pitch (what the aircraft was actually doing). Such models may be utilized during training, or may form the basis of a deterministic function.

Outputs 412 from each of the nodes 410 in the input layer 402 are passed to each node 436 in a first intermediate layer 406. The process continues through any number of intermediate layers 406, 408 with each intermediate layer node 436, 438 having a unique set of synaptic weights corresponding to each input 412, 414 from the previous intermediate layer 406, 408. It is envisioned that certain intermediate layer nodes 436, 438 may produce a real value with a range while other intermediate layer nodes 436, 438 may produce a Boolean value. Furthermore, it is envisioned that certain intermediate layer nodes 436, 438 may utilize a weighted input summation methodology while others utilize a weighted input product methodology. It is further envisioned that synaptic weight may correspond to bit shifting of the corresponding inputs 412, 414, 416.

An output layer 404 including one or more output nodes 440 receives the outputs 416 from each of the nodes 438 in the previous intermediate layer 408. Each output node 440 produces a final output 426, 428, 430, 432, 434 via processing the previous layer inputs 416. Such outputs 426, 428, 430, 432, 434 may comprise separate components of an interleaved input signal, bits for delivery to a register, or other digital output based on an input signal and DSP algorithm.

The final outputs 426, 428, 430, 432, 434 generally correspond to an indication of whether the state of the aircraft indicates a risk of perception-based incapacitation due to perceived pitch being different from the actual pitch of the aircraft. Furthermore, the final outputs 426, 428, 430, 432, 434 may generally correspond to an analysis of a pilot’s actions when perception-based incapacitation is likely.

In at least one embodiment, when perception-based incapacitation is likely, the final outputs 426, 428, 430, 432, 434 may correspond to a shift of control authority or notification of some sort depending on the autonomy of the aircraft. For example, the system may send a notification to flight crew that the pilot may be experiencing perception-based incapacitation.

In at least one embodiment, each node 410, 436, 438, 440 in any layer 402, 406, 408, 404 may include a node weight to boost the output value of that node 410, 436, 438, 440 independent of the weighting applied to the output of that node 410, 436, 438, 440 in subsequent layers 404, 406, 408. It may be appreciated that certain synaptic weights may be zero to effectively isolate a node 410, 436, 438, 440 from an input 412, 414, 416, from one or more nodes 410, 436, 438 in a previous layer, or an initial input 418, 420, 422, 424.

In at least one embodiment, the number of processing layers 402, 404, 406, 408 may be constrained at a design phase based on a desired data throughput rate. Furthermore, multiple processors and multiple processing threads may facilitate simultaneous calculations of nodes 410, 436, 438, 440 within each processing layers 402, 404, 406, 408.

Layers 402, 404, 406, 408 may be organized in a feed forward architecture where nodes 410, 436, 438, 440 only receive inputs from the previous layer 402, 404, 406 or initial input 418, 420, 422, 424 and deliver outputs only to the immediately subsequent layer 404, 406, 408, or a recurrent architecture, or some combination thereof.

It is believed that the inventive concepts disclosed herein and many of their attendant advantages will be understood by the foregoing description of embodiments of the inventive concepts, and it will be apparent that various changes may be made in the form, construction, and arrangement of the components thereof without departing from the broad scope of the inventive concepts disclosed herein or without sacrificing all of their material advantages; and individual features from various embodiments may be combined to arrive at other embodiments. The forms herein before described being merely explanatory embodiments thereof, it is the intention of the following claims to encompass and include such changes. Furthermore, any of the features disclosed in relation to any of the individual embodiments may be incorporated into any other embodiment.

What is claimed is:

1. A computer apparatus comprising:
at least one processor in data communication with a memory storing processor executable code for configuring the at least one processor to:
receive inputs from a flight management system;
determine, based on the inputs from the flight management system, that an aircraft is in a state likely to result in perception-based incapacitation; and
execute a remedial action to mitigate the perception-based incapacitation.

2. The computer apparatus of claim 1, wherein the at least one processor is further configured to:
receive one or more pilot inputs; and
compare the one or more pilot inputs to a set of pilot inputs corresponding to an erroneous perceived pitch.

3. The computer apparatus of claim 1, wherein the remedial action comprises an assumption of control of the aircraft.

4. The computer apparatus of claim 1, wherein the inputs from the flight management system comprises at least aircraft actual pitch and velocity data over time.

5. The computer apparatus of claim 4, wherein the inputs from the flight management system further comprises flight phase data.

6. The computer apparatus of claim 1, wherein the remedial action comprises a notification of potential perception-based incapacitation to a flight crew.

7. The computer apparatus of claim 1, wherein the at least one processor is configured to embody a trained neural network.

8. An aircraft comprising:
a flight management system; and
at least one processor in data communication with the flight management system and a memory storing processor executable code for configuring the at least one processor to:
receive inputs from the flight management system;
determine, based on the inputs from the flight management system, that the aircraft is in a state likely to result in perception-based incapacitation; and
execute a remedial action to mitigate the perception-based incapacitation.

9. The aircraft of claim 8, wherein the at least one processor is further configured to:
receive one or more pilot inputs; and
compare the one or more pilot inputs to a set of pilot inputs corresponding to an erroneous perceived pitch.

10. The aircraft of claim 8, wherein the remedial action comprises an assumption of control of the aircraft.

11. The aircraft of claim 8, wherein the inputs from the flight management system comprises at least aircraft actual pitch and velocity data over time.

12. The aircraft of claim 11, wherein the inputs from the flight management system further comprises flight phase data.

13. The aircraft of claim 8, wherein the remedial action comprises a notification of potential perception-based incapacitation to a flight crew.

14. The aircraft of claim 8, wherein the at least one processor is configured to embody a trained neural network.

15. A pilot monitoring system comprising:
at least one processor in data communication with a memory storing processor executable code for configuring the at least one processor to:
receive inputs from a flight management system;
determine, based on the inputs from the flight management system, that an aircraft is in a state likely to result in perception-based incapacitation; and
execute a remedial action to mitigate the perception-based incapacitation.

16. The pilot monitoring system of claim 15, wherein the at least one processor is further configured to:
receive one or more pilot inputs; and
compare the one or more pilot inputs to a set of pilot inputs corresponding to an erroneous perceived pitch.

17. The pilot monitoring system of claim 15, wherein the remedial action comprises an assumption of control of the aircraft.

18. The pilot monitoring system of claim 15, wherein the inputs from the flight management system comprises at least aircraft actual pitch and velocity data over time, and flight phase data.

19. The pilot monitoring system of claim 15, wherein the remedial action comprises a notification of potential perception-based incapacitation to a flight crew.

20. The pilot monitoring system of claim 15, wherein the at least one processor is configured to embody a trained neural network.
